(19) United States
(12) Patent Application Publication
(10) Pub. No.: US 2024/0094477 A1
(43) Pub. Date: Mar. 21, 2024

(54) OPTICAL COUPLING PART AND OPTICAL SWITCH

(71) Applicant: NIPPON TELEGRAPH AND TELEPHONE CORPORATION, Tokyo (JP)

(72) Inventors: Chisato FUKAI, Musashino-shi, Tokyo (JP); Yoshiteru ABE, Musashino-shi, Tokyo (JP); Kunihiro TOGE, Musashino-shi, Tokyo (JP); Kazunori KATAYAMA, Musashino-shi, Tokyo (JP)

(73) Assignee: NIPPON TELEGRAPH AND TELEPHONE CORPORATION, Tokyo (JP)

(21) Appl. No.: 18/271,899

(22) PCT Filed: Jan. 27, 2021
(86) PCT No.: PCT/JP2021/002721

§ 371 Date: Jul. 12, 2023

(51) Int. Cl. G02B 6/38; G02B 6/40

(52) U.S. Cl. CPC G02B 6/3874; G02B 6/3871; G02B 6/403

(57) ABSTRACT

An objective of the present disclosure is to provide an optical coupler and an optical switch capable of achieving stable optical characteristics with low power consumption and more economical efficiency with respect to external factors. To achieve the objective, an optical coupler according to the present disclosure includes: a first ferrule in which core centers of one or a plurality of single core fibers are arranged on the same circumference from the center on a fiber cross-section;
a second ferrule in which core centers of a plurality of single core fibers are arranged on a circumference of the same diameter as the circumference of the first ferrule in which the core centers of the single core fibers are arranged from the center on the fiber cross-section; and
a cylindrical sleeve which has a hollow portion into which the first and second ferrules are inserted so that central axes of the first and second ferrules are aligned with each other with a predetermined gap between each of outer diameters of the first and second ferrules and an inner diameter of the hollow portion so that the first and second ferrules can rotate.

### TECHNICAL FIELD

The present invention relates to an optical coupler used mainly for switching a path of an optical line using a single mode optical fiber in an optical fiber network, and an optical switch using the optical coupler.

### BACKGROUND ART

Various schemes have been proposed, for example, as disclosed in NPL 1, for all optical switches that perform path switching of light as it is. Of the optical switches, optical fiber type mechanical optical switches that control aligning of optical fibers or optical connectors by robot arms, motors, or the like are inferior to other systems in terms of a low switching speed, but are superior to the other systems in terms of low loss, low wavelength dependency, a multi-port property, and a self-holding function of holding a switching state when power is lost. As typical structures, for example, there are a scheme of moving a stage using optical fiber V-shaped grooves in parallel, a scheme of selectively coupling a plurality of optical fibers emitted from incident optical fibers by moving a mirror or a prism in parallel or changing an angle of the mirror or the prism, and a scheme of connecting a jumper cable with an optical connector using a robot arm.

Also, a method of using a multi-core fiber as an optical path for switching has been proposed. For example, multi-paths can be switched collectively by combining a three-dimensional MEMS optical switch with a multi-core fiber (for example, see NPL 2). Further, since switching is performed by rotating a cylindrical ferrule into which a multi-core fiber is inserted (for example, see Patent Literature 1), optical components such as a lens and a prism are not required, and thus the structure can be simplified.

### CITATION LIST

### Patent Literature

[PTL 1] Japanese Unexamined Patent Publication No. 2-82212

### Non Patent Literature

[NPL 1] Ctepanosky, “A Comparative Review of MEMS-based Optical Cross-Connects for All-optical networks From the Past to the Present Day,” IEEE Communications Surveys & Tutorials, vol. 21, no 3, pp. 2928-2946, 2019
[NPL 2] K. Hiruma, T. Sugawara, K. Tanaka, E. Nomoto, and Y. Lee, “Proposal of High-capacity and High-reliability Optical Switch Equipmet with Multi-core Fibers,” 18th OptoElectronics and Communications Conference held jointly with 2013 International Conference on Photonics in Switching (OECC/PS), ThT1-2, 2013.
[NPL 3] B. Jian, “The Non-Contact Connector: A New Category of Optical Fiber Connector,” 2015 Optical Fiber Communications Conference and Exhibition (OFC), W2A. 1,201-5:
[NPL 4] Hajime Ario, Sho Yakabe, Fumiya Uehara, Dai Sasaki, Takayuki Shimazu, “FlexAirConnecT: Dust Insensitive Multi-Fiber Connector with Low Loss and Low Mating Force” July, 2018, SEI Technical Review, No. 193, pp 26 to 31, 2018.

### SUMMARY OF INVENTION

### Technical Problem

However, the technology of the related art described in the above-mentioned NPL 1 has a problem that new low power consumption, miniaturization, and economization are difficult. Specifically, in the above-mentioned scheme of moving the V-shaped groove stage or prism in parallel, a motor is generally used as a driving source. However, since this is a mechanism for moving a heavy object such as a stage linearly, a torque of a predetermined value or more is required for the motor, power consumption being required to obtain a corresponding output in order to maintain the required torque. In optical axis alignment in which a single mode optical fiber is used, accuracy of about 1 μm or less is required. Therefore, in a mechanism that converts a rotational motion of a motor into a linear motion (in general, a ball screw is used), it is necessary to convert a rotational motion into a linear motion in sub-μm steps. When it is considered that an optical fiber pitch of an optical fiber array on an output side which is usually used is about 125 μm which is a cladding outer diameter of an optical fiber or about 250 μm which is the cladding outer diameter of the optical fiber, an actual driving time of the motor cannot but increase as an optical fiber array on the output side increase in size, and thus there is a problem that power consumption increases. Therefore, an optical fiber type mechanical optical switch generally requires electric power of several hundred mW or more. In a robot arm scheme of using an optical connector, there is a problem that large electric power of several tens of W or more is required for the robot arm itself that controls insertion and extraction of an optical connector or a ferrule.

In optical path switching in which a multicore fiber described in NPL 2 is used, a collimating mechanism that performs coupling to an optical fiber array on the output side and a vibration eliminating mechanism that obtains stable optical characteristics against external factors such as vibration are separately required in a process in which an optical switch is manufactured, and thus there is a problem that an assembling process also becomes complicated.

In optical path switching in which a cylindrical ferrule into which the multicore fiber disclosed in NPL 1 is inserted is used, a ferrule is closely inserted into a sleeve to align the central axis, and thus there is a problem that a large energy for driving rotation is required and large power is necessary due to a frictional force between the ferrule and the sleeve. Further, in order to prevent deterioration in optical characteristics such as a connection loss due to damages occurring on facing fiber end surfaces when the ferrule rotates, a mechanism separating the ferrule end surfaces whenever the ferrule rotates is required, and energy unnecessary for driving rotation is required.

On the other hand, in a cylindrical ferrule into which an optical fiber is inserted, there is also a method of preventing the fiber end surfaces from being damaged due to contacts by using a connection form in which fibers are not brought into contact with each other by forming a gap in advance (for example, NPL 3). However, in order to suppress deterioration in a signal due to reflection caused by an air layer generated between the fiber end surfaces in the gap, a special coating for preventing reflection is required, and thus there is a problem that cost increases.

As another method of preventing reflection, there is a method for polishing a ferrule end surface obliquely (for example, NPL 4). However, in the polished obliquely ferrule, there is a problem that interference of the ferrule end surfaces occurs during switching by rotation or a large gap is required, and thus there is a problem that a connection loss increases.

In order to solve the foregoing problems, an objective of the present invention is to provide an optical coupler and an optical switch capable of achieving stable optical characteristics with low power consumption and more economical efficiency with respect to external factors.

### Solution to Problem

In order to achieve the foregoing objective, in the optical coupler and the optical switch of the present disclosure, the ends of two ferrules in which single core fibers are arranged parallel to the central axis and at the same distance from the central axis have a bulging shape, and the tips S11 of the ends of the two ferrules are abutted so that the central axes are aligned, and one of the ferrules is rotated about the central axis

Specifically, an optical coupler according to the present disclosure includes:
a first ferrule in which core centers of one or a plurality of single core fibers are arranged on the same circumference with reference to the center on a fiber cross-section;
a second ferrule in which core centers of a plurality of single core fibers are arranged on a circumference of the same diameter as that of the circumference of the first ferrule in which the core centers of the single core fibers are arranged from the center on the fiber cross-section; and
a cylindrical sleeve which has a hollow portion into which the first and second ferrules are inserted so that central axes of the first and second ferrules are aligned with each other with a predetermined gap between each of outer diameters of the first and second ferrules and an inner diameter of the hollow portion so that the first and second ferrules can rotate.

Specifically, in the optical coupler according to the present disclosure,
each of the first and second ferrules may have
a bulging shape in a central axis direction.

An end of the first ferrule may be formed by a bulging tip and an annular portion which is arranged in an outer periphery of the tip and from which an end surface of the single core fiber arranged in the first ferrule is exposed.

An end of the second ferrule may be formed by a bulging tip and an annular portion which is arranged in an outer periphery of the tip and from which an end surface of the single core fiber arranged in the second ferrule is exposed.

The tip of the first ferrule and the tip of the second ferrule may be abutted.

For example, in the optical coupler according to the present disclosure,
the tip of the first ferrule and the tip of the second ferrule may be flat surfaces.

For example, in the optical coupler according to the present disclosure,
an angle formed by the tip and the annular portion is equal to or greater than 5 degrees in each of the first ferrule and the second ferrule.

For example, in the optical coupler according to the present disclosure,
a gap between an end surface of the single core fiber exposed to the annular portion of the first ferrule and an end surface of the single core fiber exposed to the annular portion of the second ferrule of which an optical axis aligns the single core fiber may be equal to or less than 20 μm.

For example, in the optical coupler according to the present disclosure,
in each of the first and second ferrules,
the tip may be a circle with a diameter of 170 μm to 1800 μm, and
a radius of the circumference may be a radius from 200 μm to 1000 μm.

Specifically, an optical switch according to the present disclosure includes
the optical coupler; and
a rotational mechanism configured to rotate one of the first and second ferrules of the optical coupler about a central axis.

For example, the optical switch according to the present disclosure further includes:
an actuator configured to rotate the rotational mechanism at a given angular step and stopping the rotational mechanism at an arbitrary angular step; and
a bearing included in the rotational mechanism.

According to the present invention, the ends of two ferrules in which single core fibers are arranged parallel to the central axis and at the same distance from the central axis have a bulging shape, and the tips of the ends of the two ferrules are abutted so that the central axes are aligned, and one of the ferrules is rotated about the central axis, and thus it is possible to prevent deterioration in the optical characteristics of the end surfaces of the facing optical fibers, such as a connection loss caused due to damage on the end surfaces of the optical fibers by contact, without contact between the end surfaces of the facing optical fibers. Since a reflection amount of light can be reduced by causing the end surfaces of the facing optical fibers not to be parallel with each other, a more economical optical coupler and optical switch can be provided without requiring reflection coating.

Further, according to the present invention, since one of the input side and the output side of the optical coupler for performing optical switching is formed as an axially rotatable mechanism, energy required for the actuator, that is, a torque output can be made very small and power consumption can be reduced. Since an optical axis deviation amount in a direction other than axial rotation of the input-side ferrule is guaranteed by the sleeve in the optical coupler, a loss can be reduced. In addition, according to the present invention, miniaturization and economic efficiency can be achieved because a collimator or a special ant-vibration mechanism is not included and optical connection components such as a ferrule and a sleeve which are generally used are configured.

The foregoing inventions can be combined wherever possible.

### Advantageous Effects of Invention

According to the present disclosure, it is possible to provide an optical coupler and an optical switch capable of achieving stable optical characteristics with low power consumption and more economical efficiency with respect to external factors.

### BRIEF DESCRIPTION OF DRAWINGS

FIG. 1 is a diagram illustrating an example of a usage form according to the present invention.

FIG. 2 is a diagram illustrating an example of a schematic configuration according to the present invention.

FIG. 3 is a front view illustrating an end of the input-side ferrule.

FIG. 4 is a front view illustrating an end of the output-side ferrule.

FIG. 5 is a diagram illustrating an optical coupler on a plane in longitudinal direction.

FIG. 6 is a diagram illustrating an example of an excessive loss relation of clearance between an outer ferrule diameter and an inner sleeve diameter.

FIG. 7 is a diagram illustrating the vicinity of a ferrule end of the optical coupler according to the present invention.

FIG. 8 is a diagram illustrating an example of a relation between an angle formed by the tip and the annular portion and a reflection attenuation amount.

FIG. 9 is a diagram illustrating an example of the relation between an excessive loss and a gap of an optical fiber.

FIG. 10 is a diagram illustrating an example of a relation between a tip diameter and a core arrangement radius.

FIG. 11 is a diagram illustrating an example of a relation between the core arrangement radius and the number of optical fibers on the output-side ferrule.

FIG. 12 is a diagram illustrating an example of a relation between the core arrangement radius and an excessive loss due to rotational angle deviation.

FIG. 13 is a diagram illustrating a fitting form of the optical coupler according to a first embodiment of the present invention.

FIG. 14 is a diagram illustrating a fitting form of the optical coupler according to a second embodiment of the present invention.

FIG. 15 is a diagram illustrating a cross-section of an output-side ferrule of the optical coupler according to the second embodiment of the present invention.

FIG. 16 is a diagram illustrating a cross-section of an output-side ferrule of the optical coupler according to the second embodiment of the present invention.

FIG. 17 is a diagram illustrating a cross-section of an output-side flange according to the first embodiment of the present invention.

FIG. 18 is a diagram illustrating a side surface of the output-side flange according to the first embodiment of the present invention.

### DESCRIPTION OF EMBODIMENTS

Hereinafter, embodiments of the present disclosure will be described in detail below with reference to the drawings. The present invention is not limited to the embodiments to be described below. These embodiments are merely exemplary and the present disclosure can be implemented in various modified and improved modes based on the knowledge of those skilled in the art. Constituent elements with the same reference signs in the present specifications and the drawings are identical to each other.

### First Embodiment

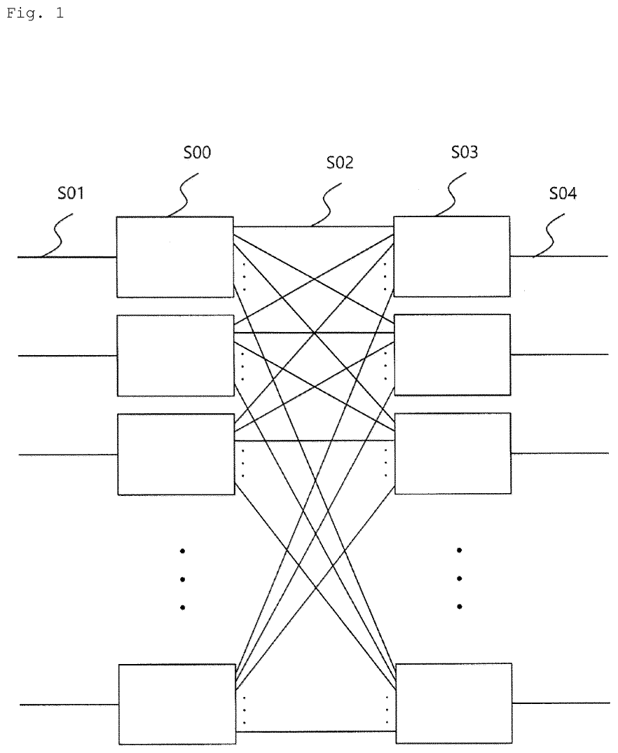

FIG. 1 is a diagram illustrating an example of an embodiment according to the present invention. In the present embodiment, a mode in which light is incident from an input-side optical fiber S01 and is emitted to an output-side optical fiber S04 will be described, but a direction of light may be reverse. In the present invention, the input-side optical fiber S01 connected to the front-stage optical switch constituent unit S00 is switched to a specific port of an optical fiber S02 between optical switches in the front-stage optical switch constituent unit S00, and the port of the optical fiber S02 between the optical switches can be switched to a desired output-side optical fiber S04 in a rear-stage optical switch constituent unit S03. The present invention relates to an optical switch corresponding to a front-stage optical switch constituent unit S00 and a rear-stage optical switch constituent unit S03. Hereinafter, the front-stage optical switch constituent unit S00 is abbreviated as the optical switch S00, and the rear-stage optical switch constituent unit S03 is abbreviated as the optical switch S03. Since the optical switch S00 and the optical switch S03 are in a horizontal reversion relation and have the same configuration, a detailed configuration of the optical switch S00 will be described.

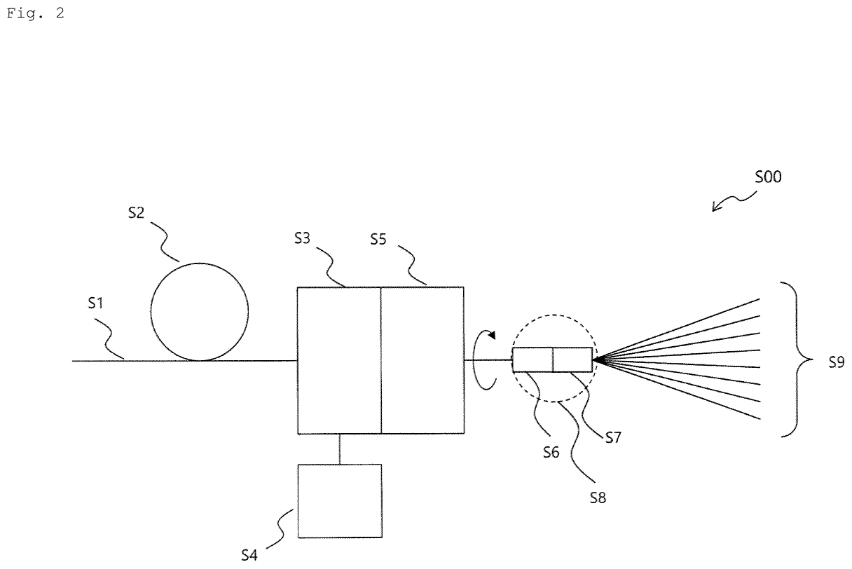

FIG. 2 is a block diagram illustrating a configuration according to an embodiment of the present invention.

An optical coupler S8 included in the optical switch S00 according to the present embodiment includes:
a first ferrule in which core centers of one or a plurality of single core fibers are arranged on the same circumference from the center on a fiber cross-section,
a second ferrule in which core centers of a plurality of single core fibers are arranged on a circumference of the same diameter as a circumference of the first ferrule in which the core centers of the single core fibers are arranged from the center on the fiber cross-section; and
a cylindrical sleeve S17 that has a hollow portion into which the first and second ferrules are inserted so that central axes of the first and second ferrules are aligned with each other with a predetermined gap between each of outer diameters of the first and second ferrules and an inner diameter of the hollow portion so that the first and second ferrules can rotate. In FIG. 2, an input-side optical fiber S1 is formed from one single core fiber, and an input-side ferrule S6 is set as a first ferrule. An output-side optical fiber S9 is formed from a plurality of single core fibers, and an output-side ferrule S7 is set as a second ferrule. The input-side optical fiber S1 corresponds to the input-side optical fiber S01 in FIG. 1, and the output-side optical fiber S9 corresponds to the optical fiber S02 between optical switches in FIG. 1.

The optical switch S00 illustrated in FIG. 2 has the optical coupler S8 that includes an input-side ferrule S6 into which the input-side optical fiber S1 is inserted and an output-side ferrule S7 into which the output-side optical fiber S9 is inserted. The optical switch is the optical switch S00 in which, when light is incident from the input-side optical fiber S1, the input-side optical fiber S1 is caused to be connected to any one core of the output-side optical fiber S9 by fixing the output-side ferrule S7 and rotating the input-side ferrule S6, and the incident light can be output from one core of the output-side optical fiber S9 and which can be used as a 1×N relay optical switch. Conversely, light can also be incident from the output-side optical fiber S9. For example, by causing light to be incident on a plurality of single core fibers among the output-side optical fibers S9, fixing the output-side ferrule S7, and rotating the input-side ferrule S6, any one core of the output-side optical fiber S9 can be connected to the input-side optical fiber S1, and only one light selected from the plurality of pieces of incident light can be output from the input-side optical fiber S1. As illustrated in FIG. 1, by combining the plurality of optical switches, it is possible to configure an N×N optical switches. Here, the output-side ferrule S7 is fixed and the input-side ferrule S6 is rotated. However, since switching of the facing fibers is enabled by fixing either the input-side ferrule S6 or the output-side ferrule S7 and rotating the facing side, the input-side ferrule S6 may be fixed and the output-side ferrule S7 may be rotated. Further, although the input-side ferrule S6 is one core, a plurality of optical fibers can also be arranged.

Hereinafter, the optical switch S00 in which the output-side ferrule S7 is fixed and the input-side ferrule S6 is rotated will be described below. The output-side ferrule S7 is fixed not to be axially rotated by a rotation prevention mechanism (not illustrated). The actuator S3 performs rotation at any angle in accordance with a signal from a control circuit S4. The input-side ferrule S6 is rotated when an output of the actuator S3 is transmitted via a rotational mechanism S5. The input-side ferrule S6 is provided with a given excess length portion S2 allowing distortion of the input-side optical fiber S1. The optical coupler S8 is configured to inhibit axial deviation with an axial deviation adjustment mechanism (not illustrated) and avoid an excessive loss due to axial deviation.

In the optical coupler S8 included in the optical switch S00 according to the present embodiment,
each of the input-side ferrule S6 and the output-side ferrule S7 includes
an end having a bulging shape in a central axis direction.

The end of the input-side ferrule S6 includes a bulging tip S11 and an annular portion S13 which is arranged in the outer periphery of the tip S11 and from which the end surface of the input-side optical fiber S1 arranged in the input-side ferrule S6 is exposed,
An end of the output-side ferrule S7 is composed of a bulging tip S11 and an annular portion S13 which is arranged in an outer periphery of the tip S11 and from which an end surface of an output-side optical fiber S9 arranged in the output-side ferrule S7 is exposed,
The tip S11 of the input-side ferrule S6 and the tip S11 of the output-side ferrule S7 are abutted.

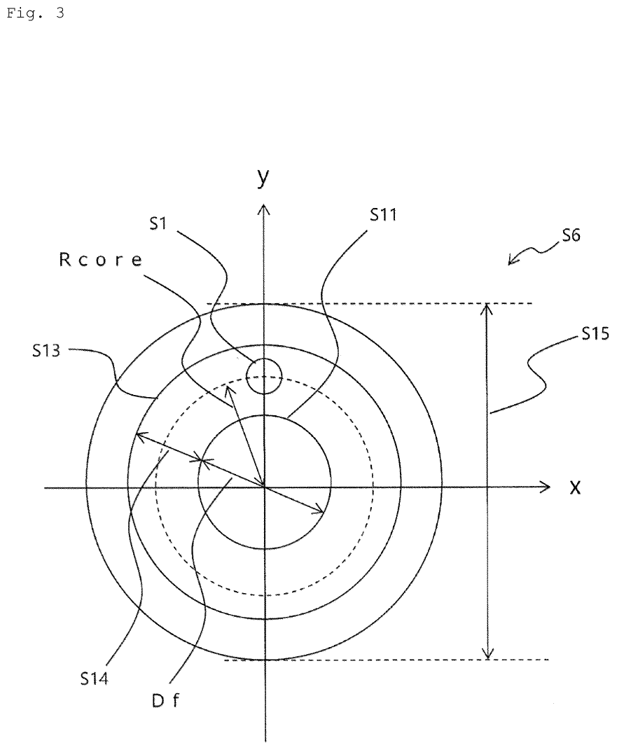

FIG. 3 is a schematic view illustrating an end of the input-side ferrule S6 according to an embodiment of the present invention from the front. As illustrated in FIG. 3, the core center of the input-side optical fiber S1 is arranged on the circumference of a circle with a core arrangement radius Rcore with respect to the center of the input-side ferrule S6. In FIG. 3, an example in which a one-core input-side optical fiber S1 is arranged on the y-axis (x=0) is given, but the core center of the input-side optical fiber S1 may be arranged on the circumference of a circle with the core arrangement radius Rcore and the present invention is not limited thereto.

The input-side optical fiber S1 is arranged in an annular portion S13 of an annular ring arranged outside the tip S11. Further, the end surface of the input-side optical fiber S1 is exposed to the annular portion S13.

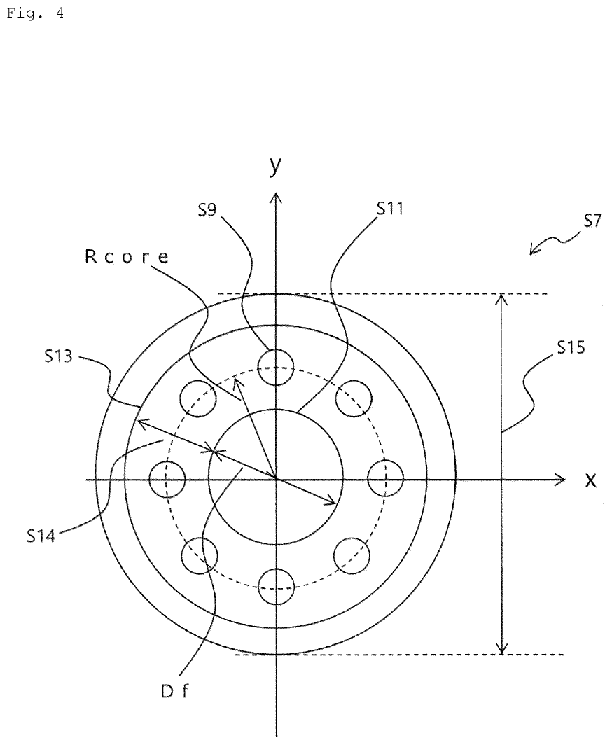

FIG. 4 is a schematic view illustrating the end of the output-side ferrule S7 according to the embodiment of the present invention from the front. As illustrated in the drawing, the core centers of the plurality of output-side optical fibers S9 are each arranged on the circumference of a circle with the core arrangement radius Rcore with respect to the center of the output-side ferrule S7. In FIG. 4, an example in which eight output-side optical fibers S9 are arranged in total is given, but the core centers of the plurality of output-side optical fibers S9 may be arranged on the circumference of a circle with the core arrangement radius Rcore, and the present invention is not limited thereto. The output-side optical fibers S9 are arranged in an annular portion S13 of an annular ring arranged outside of the tip S11, as in the input-side optical fiber S1. Further, the end surfaces of the output-side optical fibers S9 are exposed to the annular portion S13.

It is important to reduce a transmission loss of the optical coupler S8 as much as possible, and the cores of the output-side optical fibers S9 preferably have the same optical characteristics in that a mode field diameter is approximately the same degree as the core of the input-side optical fiber S1. Further, it is important to minimize an excessive loss due to axial deviation, and it is preferable that the outer ferrule diameter S15 of the output-side ferrule S7 be approximately the same as the outer ferrule diameter S15 of the input-side ferrule S6.

In the present embodiment, the input-side ferrule S6 and the output-side ferrule S7 are formed of quartz glass, but the present invention is not limited thereto as long as the optical fiber can communicate signal light in a communication wavelength band. In the present embodiment, an example in which the tips S11 of the input-side ferrule S6 and the output-side ferrule S7 are flat surfaces is given, but the tips S11 may not be flat. For example, one of the input-side ferrule S6 and the output-side ferrule S7 may be formed in a bulging shape, and the other ferrule may be formed in a recessed shape which comes into close contact with the bulging shape.

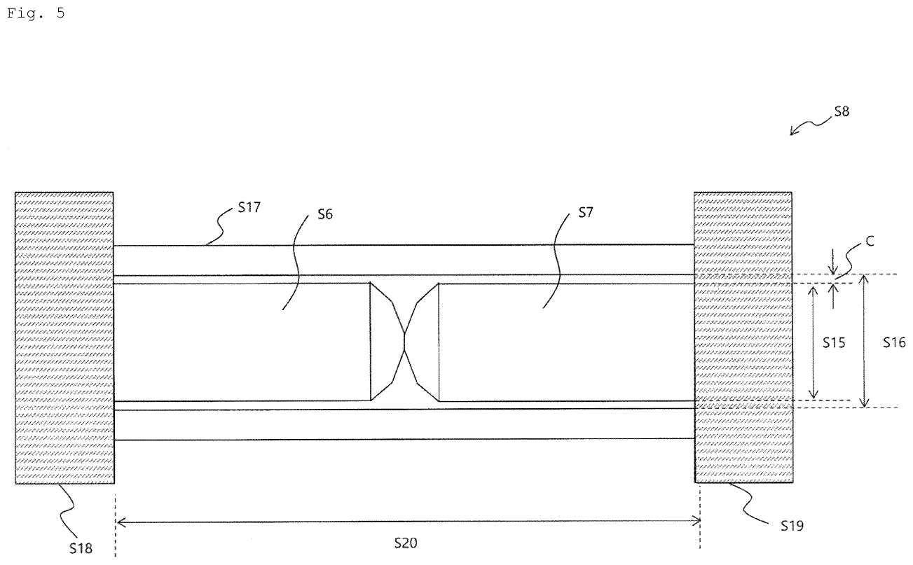

FIG. 5 is a schematic view illustrating the optical coupler S8 on a plane in a longitudinal direction according to an embodiment of the present invention. The input-side ferrule S6 into which the input-side optical fiber S1 is inserted and the output-side ferrule S7 into which the output-side optical fiber S9 is inserted are aligned by the cylindrical sleeve S17 that has an inner diameter S16 which is slightly by about sub-μm larger than an outer ferrule diameter S15 of the ferrules. A slight clearance C of about sub-μm is provided for the input-side ferrule S6 and the output-side ferrule S7 so that axial deviation is controlled with a given allowable range and the axial rotation of the input-side ferrule S6 is not obstructed.

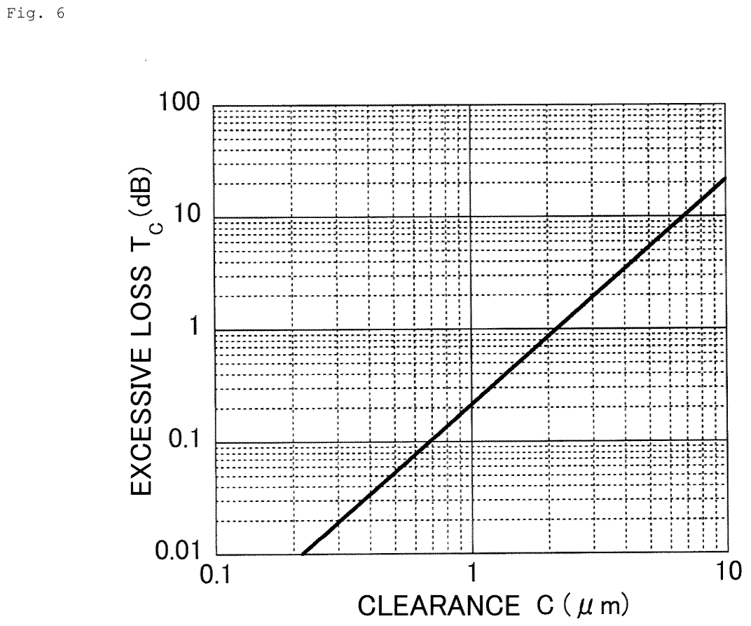

FIG. 6 is a diagram illustrating an example of a relation between the outer ferrule diameter S15 of the input-side ferrule S6 and the output-side ferrule S7 and the clearance C between the inner sleeve diameter S16 and an excessive loss T_{C}. In optical coupling between optical fibers, the axial deviation of the fiber core causes an excessive loss. Since an increase in the excessive loss causes limitation of the entire length of the optical path, it is necessary to reduce the axial deviation of the fiber core. Here, since the clearance C between the outer ferrule diameter S15 and the inner sleeve diameter S16 corresponds to the axial deviation of the fiber core, the relation between the excessive loss T_{C} (on a dB basis) and the clearance C (on a μm basis) between the outer ferrule diameter S15 and the inner sleeve diameter S16 can be expressed as in Expression. 1.

$$\begin{matrix}[ Math . 1 ] & \\ {T}_{G} = {( \frac{2 {w}_{1} {w}_{2}}{{w}_{1}^{2} + {w}_{2}^{2}} )}^{2} exp [ 1 \frac{2 {C}^{2}}{{w}_{1}^{2} + {w}_{2}^{2}} ] & ( 1 )\end{matrix}$$

Here, W₁ and W₂ are mode field radii of the input-side and output-side optical fibers S9 cores, respectively. FIG. 6 is a diagram illustrating a loss when the mode field diameters of the input-side optical fibers S1 and output-side optical fibers S9 cores are both 9 μm. For example, when the outer ferrule diameter S15 and the inner sleeve diameter S16 are processed so that the clearance C is equal to or less than 0.7 μm, a maximum excessive loss can be inhibited to about 0.1 dB or less. When the maximum excessive loss is set to 0.2 dB, it is necessary to process the outer ferrule diameter S15 and the inner sleeve diameter S16 so that the clearance C is equal to or less than 1 μm.

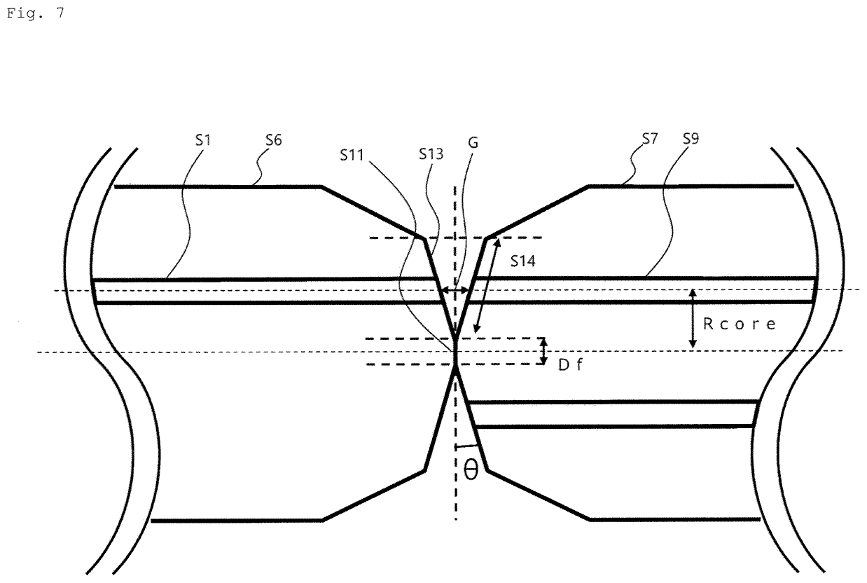

FIG. 7 is a schematic diagram illustrating the vicinity of the end of the ferrule of the optical coupler S8 in more detail according to the embodiment of the present invention. The ends of the input-side ferrule S6 and the output-side ferrule S7 have a bulging shape in a central axis direction. The tips S11 of the input-side ferrule S6 and the output-side ferrule S7 are abutted. As described above, the input-side fiber S1 and the output-side fiber S9 are arranged in the annular portion S13 of the input-side ferrule S6 and the output-side ferrule S7 and the end surfaces are exposed. The input-side fiber S1 and the output-side fiber S9 have end surfaces retreated from the tip S11 in order to prevent the respective end surfaces from being damaged due to contact during switching by rotation. An angle θ formed by the tip S11 and the annular portion S13 is controlled in order to inhibit signal characteristic deterioration due to reflection on the end surfaces of the input-side fiber S1 and the output-side fiber S9.

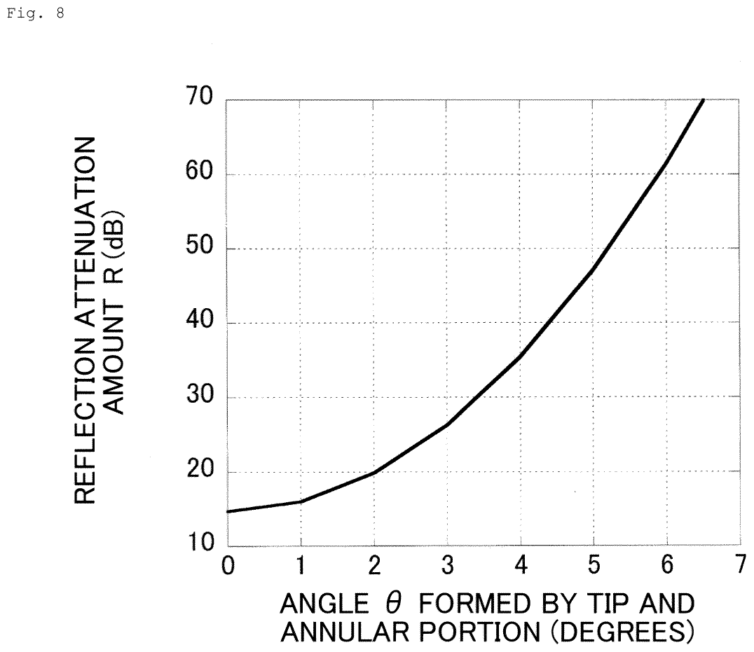

FIG. 8 is a diagram illustrating an example of a relation between the angle θ of the annular portion S13 and a reflection attenuation amount R with respect to the tip S11. In the optical coupler S8, signal characteristics deteriorate due to reflection when there is a region where a refractive index between the end surface of the input-side optical fiber S1 and the end surface of the output-side optical fiber S9 is different. In the configuration of the present invention illustrated in FIG. 7, since there is a gap G between the end surface of the input-side optical fiber S1 and the end surface of the output-side optical fiber S9 and a refractive index differs between quartz glass and the air, it is necessary to reduce reflection. The reflection is reduced by controlling the angle θ of the annular portion S13 in the present invention. A relation between the angle θ (on a degree basis) of the annular portion S13 with respect to the tip S11 and the reflection attenuation amount R (on a dB basis) can be expressed as in Expression 2.

$$\begin{matrix}[ Math . 2 ] & \\ R = 10 \frac{{( π \times {n}_{1} \times {ω}_{1} )}^{2}}{{λ}^{2}} \times log ( e ) \times {( 2 θ )}^{2} + {R}_{0} & ( 2 )\end{matrix}$$

Here, n₁, ω₁, and λ are a refractive index of each optical fiber, a mode field radius of an optical fiber core, and a signal wavelength, respectively. R₀ is a reflection attenuation amount at a flat end surface and can be expressed as in Expression (3).

$$\begin{matrix}[ Math . 3 ] & \\ {R}_{0} = - 10 \cdot log [ {( \frac{{n}_{1} - {n}_{2}}{{n}_{1} + {n}_{2}} )}^{2} ] & ( 3 )\end{matrix}$$

Here, n2 is a refractive index of a light receiving medium. In the present embodiment, when the wavelength A is 1310 nm and the mode field radius ω₁ is 4.5 μm, the reflection attenuation amount R₀ at the flat end surface is 14.7 dB. For example, by setting 5 degrees or more as an angle of the annular portion S13 to the tip S11, the reflection attenuation amount R of 40 dB or more can be held.

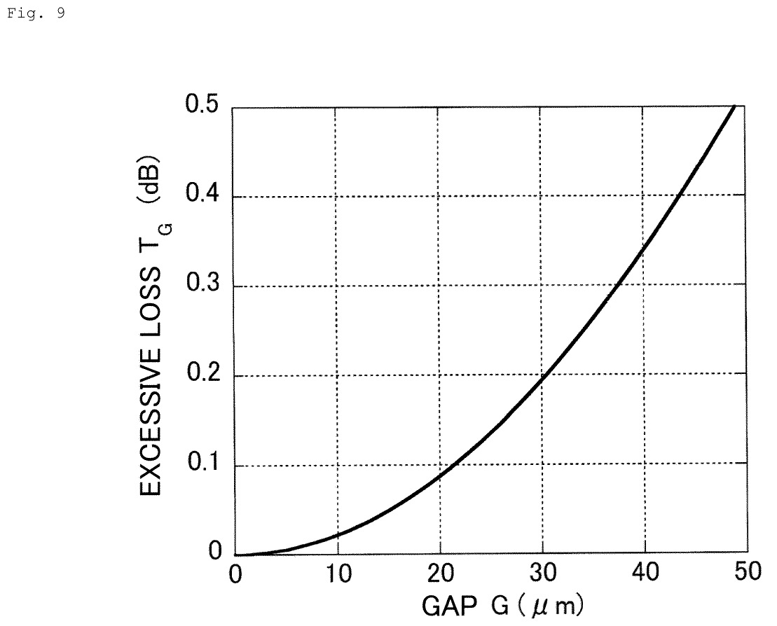

FIG. 9 is a diagram illustrating an example of a relation between the excessive loss T_{G} and the gap G. When there is the gap G between the end surface of the input-side optical fiber S1 and the end surface of the output-side optical fiber S9 in optical coupling between the input-side optical fiber S1 and the output-side optical fiber S9, a distribution of outgoing light of the input-side optical fiber S1 is widened and coupling efficiency with the core of the output-side optical fiber S9 is reduced, which causes an excessive loss. The relation between the gap G (on a μm basis) and the excessive loss T_{G} (on a dB basis) can be expressed as in Expression 4.

$$\begin{matrix}[ Math . 4 ] & \\ {T}_{G} = \frac{4 [ 4 {G}^{2} + \frac{{w}_{1}^{2}}{{w}_{2}^{2}} ]}{{[ 4 {G}^{2} + \frac{{w}_{2}^{2} + {w}_{1}^{2}}{{w}_{2}^{2}} ]}^{2} + 4 {G}^{2} \frac{{w}_{2}^{2}}{{w}_{1}^{2}}} & ( 4 )\end{matrix}$$

Here, W₁ and W₂ are the mode field radii of the cores of the input-side optical fiber S1 and the output-side optical fiber S9, respectively. FIG. 9 is a diagram illustrating a loss when the mode field diameters of the cores of the input-side optical fiber S1 and the output-side optical fiber S9 are both 9 μm. For example, by adjusting the gap G between the end surface of the input-side optical fiber S1 and the end surface of the output-side optical fiber S9 to 20 μm or less, the excessive loss can be inhibited to 0.1 dB or less.

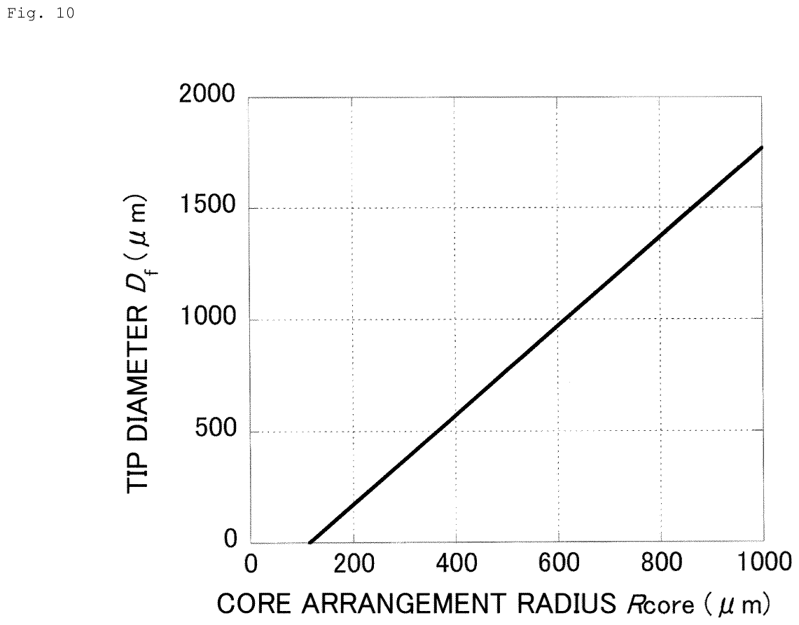

FIG. 10 is a view illustrating an example of a relation between the core arrangement radius Rcore and a tip diameter Df. In the configuration of the present invention illustrated in FIG. 7, the relation between the core arrangement radius Rcore (on a μm basis) and the tip diameter Df (on a μm basis) can be expressed as in Expression 5 by using the gap G between the end surface of the input-side optical fiber S1 and the end surface of the output-side optical fiber S9 and the angle θ of the annular portion S13.

$$\begin{matrix}[ Math . 5 ] & \\ {D}_{f} = [ {R}_{core} - \frac{G}{2} \times \frac{1}{tan ( \frac{θ \times π}{180} )} ] \times 2 & ( 5 )\end{matrix}$$

FIG. 10 illustrates the tip diameter Df when the gap G and the angle θ of the annular portion S13 are 20 μm and 5 degrees, respectively.

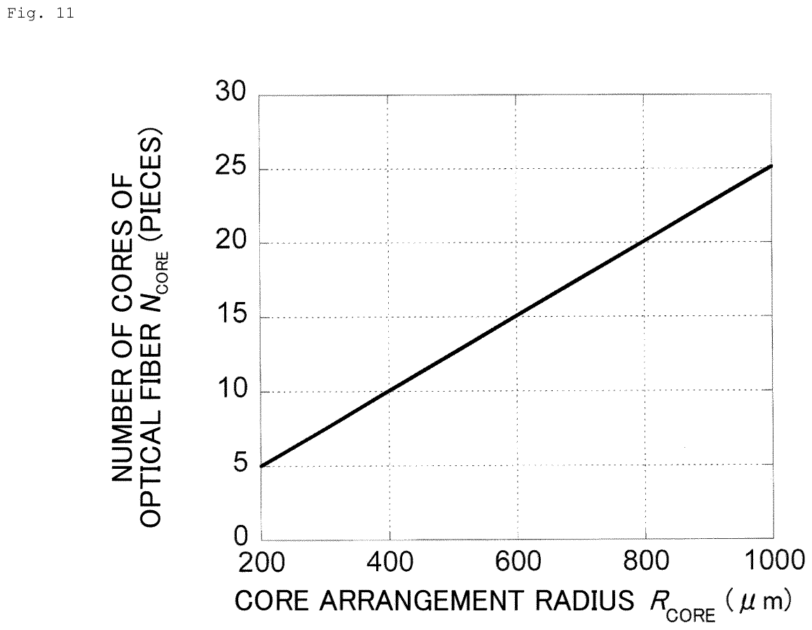

FIG. 11 is a diagram illustrating an example of the relation between the core arrangement radius Rcore and the number of cores Ncore of the optical fibers of the output-side ferrule S7. FIG. 11 illustrates an example of the number of cores of the optical fibers when the output-side optical fibers S9 are annularly arranged on the core arrangement radius Rcore and a distance between the cores of adjacent optical fibers is 250 μm. For example, with reference to FIGS. 10 and 11, twenty five ports can be switched by arranging the output-side optical fibers S9 so that the tip diameter Df of the output-side ferrule S7 is about 1800 μm, the core arrangement radius Rcore is 1000 μm, and a distance between adjacent cores is 250 μm.

In the optical coupler S8 included in the optical switch S00 according to the present embodiment,

In each of the input-side ferrule S6 and the output-side ferrule S7,
the tip S11 may be a circle with the tip diameter Df from 170 μm to 1800 μm, and
the core arrangement radius Rcore may be a radius from 200 μm to 1000 μm.

Next, requirements related to the actuator S3 illustrated in FIG. 2, the input-side ferrule S6 illustrated in FIG. 3, and the output-side ferrule S7 illustrated in FIG. 4 will be described. The actuator S3 is a driving mechanism which rotates at any angle step in accordance with a pulse signal from the control circuit S4 and has a given stationary torque at each angle step. For example, a stepping motor is used. As long as the actuator S3 is a driving mechanism that performs rotation at any angle step in accordance with a pulse signal from the control circuit S4 and has a given stationary torque at each angle step, any other method may be used. A rotational speed and a rotational angle are determined by a period and the number of pulses of a pulse signal from the control circuit S4, and the angle step and the stationary torque may be adjusted via a reduction gear. Since the input-side ferrule S6 in the optical coupler S8 is designed to rotate axially, as described, the actuator S3 applies a stationary torque necessary for holding a rotational angle of the input-side ferrule S6.

Thus, it is possible to provide that optical switch that has a self-holding function in which power is not necessary in stopping after switching, is capable of reducing driving energy as much as possible in switching of an optical path, and consumes low power.

Here, in a stepping motor, when the number of angle steps in which an angle position is held during stopping of power supply is defined as the number of stationary angle steps, the number of stationary angle steps is a natural number multiple of the number of cores with the same core arrangement radius Rcore as the output-side optical fiber S9.

When T_{R} (on a dB basis) is an excessive loss due to the deviation in a rotational angle in the optical coupler S8, Φ (on a ° basis) is rotational angle deviation related to accuracy of a stationary angle of the stepping motor, and the core arrangement radius Rcore (on a μm basis) is set, a relation therebetween can be expressed as in Expression 6.

$$\begin{matrix}[ Math . 6 ] & \\ {T}_{R} = {( \frac{2 {w}_{1} {w}_{2}}{{w}_{1}^{2} + {w}_{2}^{2}} )}^{2} exp [ 1 \frac{2 {( 2 {R}_{core} sin 2 π \frac{Φ}{360} )}^{2}}{{w}_{1}^{2} + {w}_{2}^{2}} ] & ( 6 )\end{matrix}$$

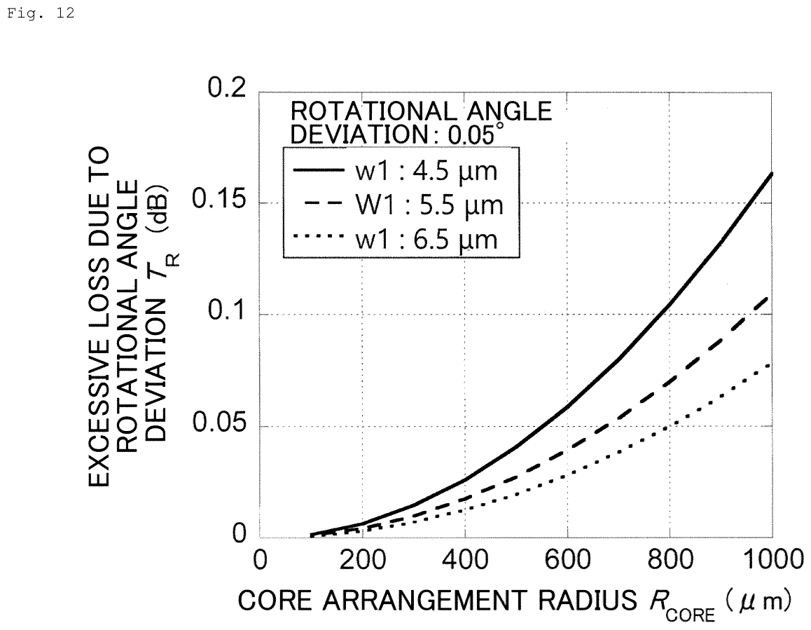

An example of the relation between the core arrangement radius Rcore and the excessive loss T_{R} due to the rotational angle deviation is illustrated in FIG. 12. In general, angular accuracy of the stepping motor is about 3 to 5% and in FIG. 12, the rotational angle deviation (is set to 0.05 degrees. The larger the core arrangement radius Rcore is, the larger the excessive loss is. Thus, strict accuracy of a stationary angle is required. For example, if an excessive loss is 0.1 dB, it is necessary for the core arrangement radius Rcore to be equal to or less than 800 μm when a mode field diameter is 9 μm. When an optical fiber with a larger mode field diameter is used, the excessive loss can be reduced.

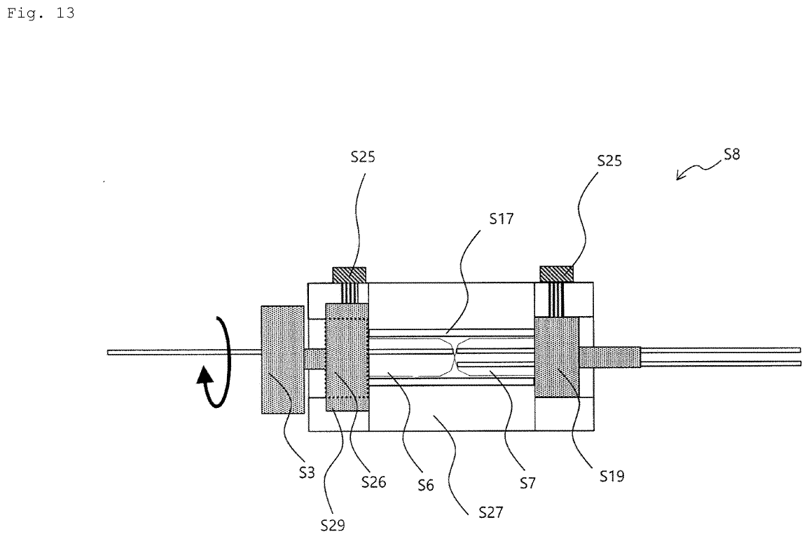

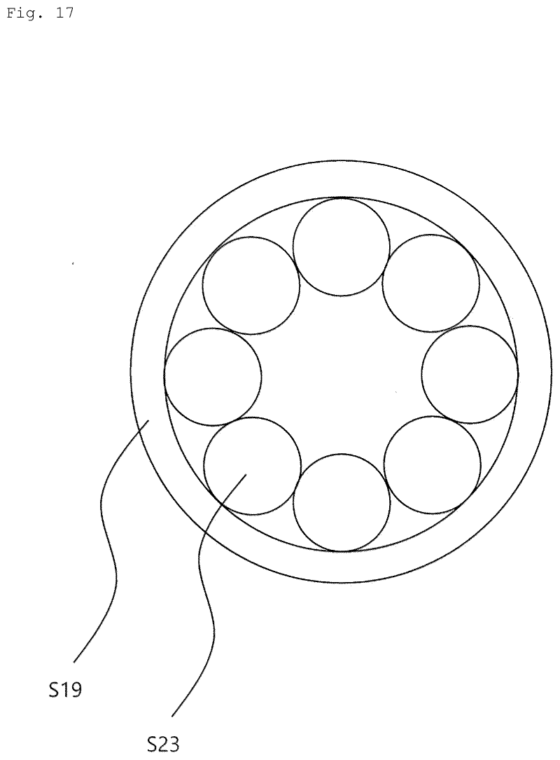

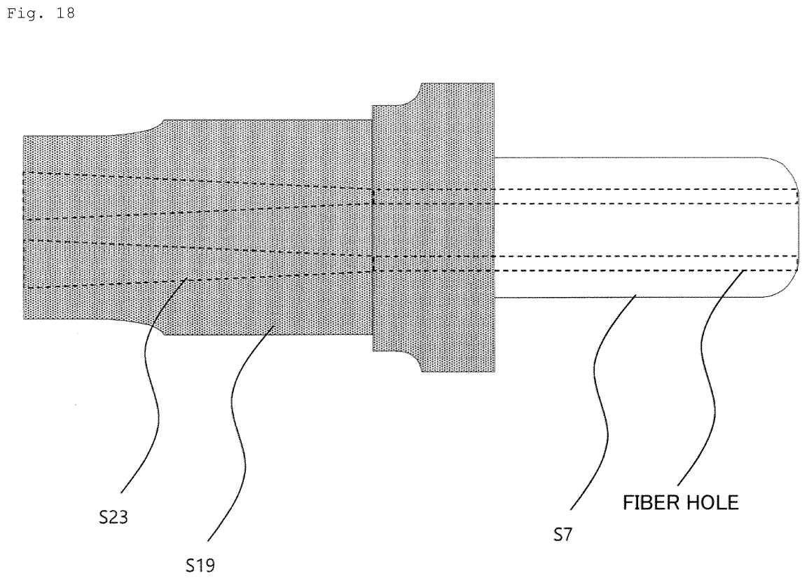

FIG. 13 is a schematic diagram illustrating a fitting form of the optical coupler S8 according to the first embodiment of the present invention. The output-side ferrule S7 is attached to an output-side flange S19 with a notch, the output-side flange 19 is attached to a fixing jig S27 by a fixing screw S25, and the axis direction and the axial rotation direction are fixed. The input-side ferrule S6 is attached to a rotational flange S29, and a bearing S26 is provided on the rotational flange S29 which is similarly attached to the fixing jig S27 by the fixing screw S25 to be fixed. The sleeve S17 is embedded inside the fixing jig S27, and the input-side ferrule S6 and the output-side ferrule S7 are inserted into the sleeve S17 to be axially aligned. The output-side ferrule S7 is fixed, and the input-side ferrule S6 is rotated by the rotational mechanism S5 of the bearing S26 about the center of a ferrule cylinder as an axis inside the sleeve S17. Thus, the core of the input-side optical fiber S1 inserted into the input-side ferrule S6 is rotated, and the core of the output-side optical fiber S9 opposed to the input-side optical fiber S1 is switched. For example, zirconia is used for the bearing S26. However, another material can also be used as long as the bearing is manufactured with high dimension accuracy. For example, by forming the fixing jig S27 with a frame made of a hollow metal with low rigidity, it is possible to reduce the axial deviation of the input-side ferrule S6 due to the axial deviation during rotation of the actuator. FIG. 17 is a cross-sectional view illustrating the output-side flange S19 with a notch attached to the output-side ferrule S7 and cut on a plane perpendicular to the longitudinal axis of the output-side flange S19. In the output-side flange S19, as illustrated in FIG. 17, a plurality of capillaries S23 may be inserted inside each flange. FIG. 18 is a side view illustrating the output-side flange S19 with a notch attached to the output-side ferrule S7. As illustrated in FIG. 18, the capillary S23 is arranged at a position at which the central axis aligns a fiber hole of the output-side ferrule S7 attached to the output-side flange S19, and thus the output-side optical fiber S9 can be easily inserted into the output-side ferrule S7. Further, as illustrated in FIG. 18, the capillary S23 is tapered in the longitudinal direction, and the diameter of the tip of the capillary S23 approaches the diameter of the fiber hole of the output-side ferrule S7, and thus preventing the output-side optical fiber S9 from being caught by a step when the output-side optical fiber S9 is inserted into the output-side ferrule S7 and the optical fiber can be prevented from being broken. The same applies to the rotational flange S29 attached to the input-side ferrule S6. In the present embodiment, an example in which a plurality of capillaries are inserted inside the flange is given, but the shape of the inside of the flange may be a shape in which an optical fiber can be inserted into a fiber hole and may be a shape in which an optical fiber can be protected when an optical connector is manufactured. The present invention is not limited thereto.

According to the present invention, the ends of two ferrules in which single core fibers are arranged parallel to the central axis and at the same distance from the central axis have a bulging shape, and the tips S11 of the ends of the two ferrules are abutted so that the central axes are aligned, and one of the ferrules is rotated about the central axis, and thus it is possible to prevent deterioration in the optical characteristics of the end surfaces of the facing optical fibers, such as a connection loss caused due to damage on the end surfaces of the optical fibers by contact, without contact between the end surfaces of the facing optical fibers. Since a reflection amount of light can be reduced by causing the end surfaces of the facing optical fibers not to be parallel with each other, a more economical optical coupler and optical switch can be provided without requiring reflection coating.

Further, according to the present invention, since one of the input side and the output side of the optical coupler S8 for performing optical switching is formed as an axially rotatable mechanism, energy required for the actuator S3, that is, a torque output can be made very small and power consumption can be reduced. Since an optical axis deviation amount in a direction other than axial rotation of the input-side ferrule S6 is guaranteed by the sleeve S17 in the optical coupler S8, a loss can be reduced. In addition, according to the present invention, miniaturization and economic efficiency can be achieved because a collimator or a special ant-vibration mechanism is not included and optical connection components such as a ferrule and a sleeve which are generally used are configured.

Accordingly, the present invention can provide an optical coupler and an optical switch which can achieve stable optical characteristics with low power consumption and more economically with respect to external factors such as temperature and vibration. As a result, it is possible to use the optical switch that switches a path in any facility regardless of a place in an optical line in which a single mode optical fiber of an optical fiber network is used.

### Second Embodiment

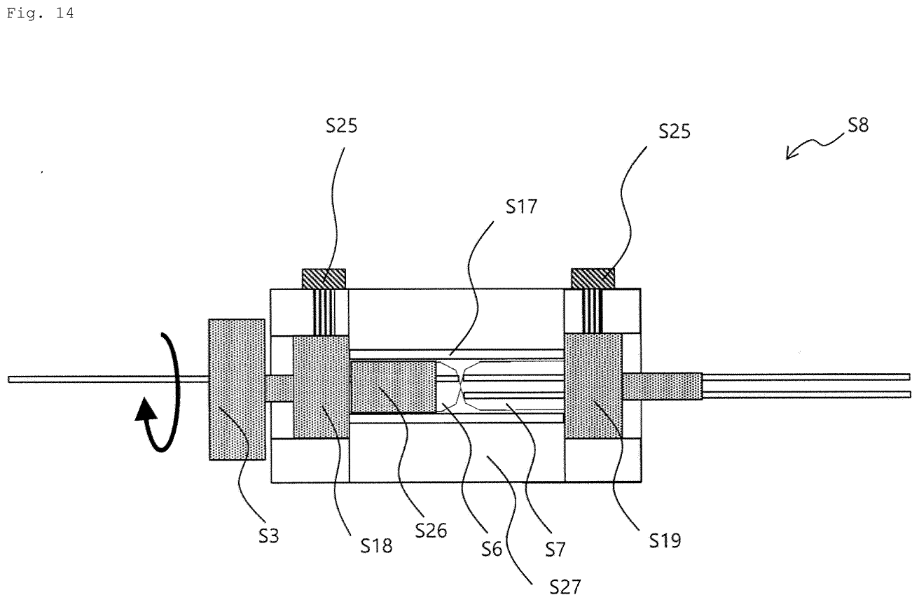

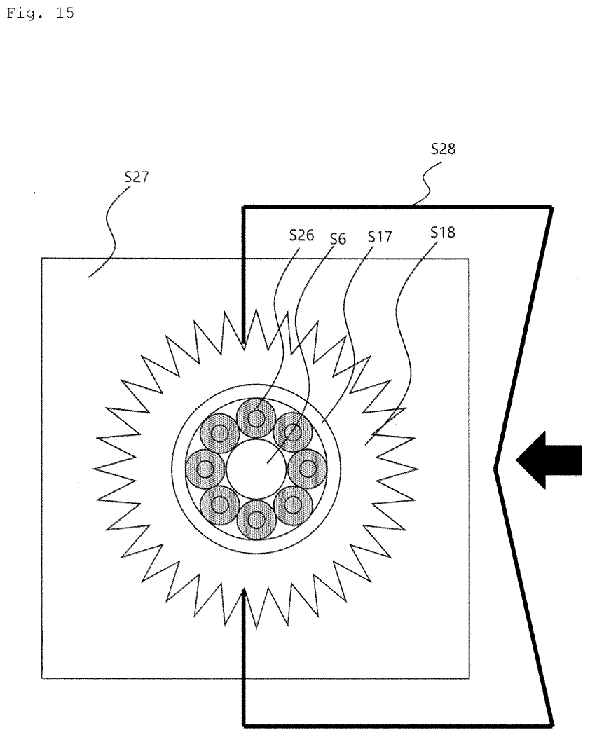

Hereinafter, a configuration and an operation of an optical switch S00 according to the present embodiment will be described specifically with reference to FIGS. 14 and 15. In the optical switch S00 according to the present embodiment, an input-side ferrule S6 of an optical coupler S8 is not attached to a rotational flange S29 but to an input-side flange S18, and a position at which the bearing S26 is provided is different from that of the optical switch S00 according to the first embodiment. Hereinafter, a rotational mechanism of the input-side ferrule S6 will be described. Other content to be described below are similar to those of the first embodiment.

FIG. 14 is a schematic diagram illustrating a fitting form of the optical coupler S8 according to the present embodiment. As in the first embodiment, the output-side ferrule S7 is attached to the output-side flange S19 with a notch, the output-side flange S19 is attached to the fixing jig S27 by the fixing screw S25, and thus the axis direction and the axial rotation direction are fixed.

The input-side ferrule S6 is attached to an input-side flange S18 with a notch. The input-side flange S18 may be attached to the fixing jig S27 by a removable fixing screw S25, and the axis direction and the axial rotation direction are fixed. By removing the fixing screw S25, the input-side flange S18 can be rotated, and the input-side ferrule S6 attached to the input-side flange S18 can be accordingly rotated. The input-side flange S18 may have a structure illustrated in FIG. 15 as will be described later. The input-side ferrule S6 has an outer ferrule diameter S15 less than that of the output-side ferrule S7, and the bearing S26 is attached and is rotated by the rotational mechanism S5 of the bearing S26. Accordingly, the core of the input-side optical fiber S1 inserted into the input-side ferrule S6 is rotated, and the core of the output-side optical fiber S9 facing the input-side optical fiber S1 is switched.

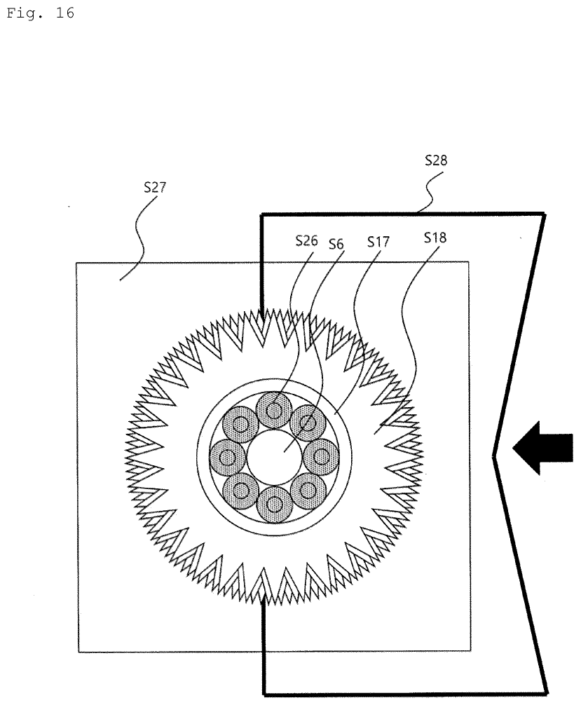

FIG. 15 is a schematic diagram illustrating a cross-section of the input-side ferrule S6 of the optical coupler S8 according to the present embodiment. The bearing S26 is attached to the periphery of the input-side ferrule S6, and the input-side ferrule S6 can freely rotate in the sleeve S17. FIG. 15 illustrates an example in which the fixing spring S28 is used as a fixing method of the input-side flange S18. A groove illustrated in FIG. 15 is previously provided in the input-side flange S18, and the input-side flange S18 and the input-side ferrule S6 fixed thereto are fixed with the tip of a fixing spring S28 therebetween in the groove. The fixing spring S28 releases the fixing of the input-side ferrule S6 to be rotatable by applying a force in a direction of an arrow. For example, the fixing and releasing of the fixing spring S28 interlock with a control circuit S4 (not illustrated) controlling the actuator S3, and thus collective control of the switching of the optical fiber can be performed. The shape of the outer periphery of the input-side flange S18 can be formed, as illustrated in FIG. 16, in a shape in which a plurality of gears are arranged so that the grooves are shifted along the longitudinal direction of the input-side ferrule S6, and thus a rotational angle can be controlled more finely. As a method of fixing and releasing the input-side flange S18, a magnet or a solenoid may be used in addition to the fixing spring S28.

As described above, according to the present invention, it is possible to provide an optical coupler and an optical switch capable of achieving stable optical characteristics with low power consumption and more economical efficiency with respect to external factors.

The above inventions can be combined wherever possible.

### INDUSTRIAL APPLICABILITY

The optical coupler and the optical switch according to the present disclosure can be applied to optical communication industries

### REFERENCE SIGNS LIST

S00 Front-stage optical switch constituent unit
S00 Optical switch
S01 Input-side optical fiber
S02 Optical fiber between optical switches
S03 Rear-stage optical switch constituent unit
S04 Output-side optical fiber
S1 Input-side optical fiber
S2 Excess length portion
S3 Actuator
S4 Control circuit
S5 Rotational mechanism
S6 Input-side ferrule
S7 Output-side ferrule
S8 Optical coupler
S9 Output-side optical fiber
S11 Tip
S13 Annular portion
S15 Outer ferrule diameter
S16 Inner sleeve diameter
S17 Sleeve
S18 Input-side flange
S19 Output-side flange
S20 Length in sleeve axis direction
S23 Capillary
S25 Fixed screw
S26 Bearing
S27 Fixing jig
S28 Fixing spring
S29 Rotational flange

1. An optical coupler comprising:
a first ferrule in which core centers of one or a plurality of single core fibers are arranged on the same circumference from the center on a fiber cross-section;
a second ferrule in which core centers of a plurality of single core fibers are arranged on a circumference of the same diameter as the circumference of the first ferrule in which the core centers of the single core fibers are arranged from the center on the fiber cross-section; and
a cylindrical sleeve which has a hollow portion into which the first and second ferrules are inserted so that central axes of the first and second ferrules are aligned with each other with a predetermined gap between each of outer diameters of the first and second ferrules and an inner diameter of the hollow portion so that the first and second ferrules can rotate.

2. The optical coupler according to claim 1,
wherein each of the first and second ferrules has a bulging shape in a central axis direction,
wherein an end of the first ferrule is formed by a bulging tip and an annular portion which is arranged in an outer periphery of the tip and from which an end surface of the single core fiber arranged in the first ferrule is exposed,
wherein an end of the second ferrule is formed by a bulging tip and an annular portion which is arranged in an outer periphery of the tip and from which an end surface of the single core fiber arranged in the second ferrule is exposed, and
wherein the tip of the first ferrule and the tip of the second ferrule are abutted.

3. The optical coupler according to claim 2, wherein the tip of the first ferrule and the tip of the second ferrule are flat surfaces.

4. The optical coupler according to claim 2, wherein an angle formed by the tip and the annular portion is equal to or greater than 5 degrees in each of the first ferrule and the second ferrule.

5. The optical coupler according to claim 2, wherein a gap between an end surface of the single core fiber exposed to the annular portion of the first ferrule and an end surface of the single core fiber exposed to the annular portion of the second ferrule of which an optical axis aligns the single core fiber is equal to or less than 20 μm.

6. The optical coupler according to claim 2, wherein, in each of the first and second ferrules,
the tip is a circle with a diameter of 170 μm to 1800 μm, and
a radius of the circumference is a radius from 200 μm to 1000 μm.

7. An optical switch comprising:
the optical coupler according to claim 1; and
a rotational mechanism configured to rotate one of the first and second ferrules of the optical coupler about a central axis.

8. The optical switch according to claim 7, further comprising:
an actuator configured to rotate the rotational mechanism at a constant angular step and stopping the rotational mechanism at an arbitrary angular step; and
a bearing included in the rotational mechanism.
